(19) United States
(12) Patent Application Publication
(10) Pub. No.: US 2007/0170729 A1
(43) Pub. Date: Jul. 26, 2007

(54) Window and window handle

(75) Inventors: Konrad Kaiser, Geseke (DE); Daniel Link, Butzbach (DE)

Correspondence Address: BARNES & THORNBURG LLP, 750-17TH STREET NW, SUITE 900, WASHINGTON, DC, 20006-4675, US

(73) Assignee: SHUCO INTERNATIONAL KG, Bielefeld (DE)

(21) Appl. No.: 10/596,967

(22) PCT Filed: Dec. 14, 2004
(86) PCT No.: PCT/EP04/14239

§ 371 Date: Jun. 30, 2006

(30) Foreign Application Priority Data
Dec. 31, 2003 (DE) 103 61 774.4
Aug. 4, 2004 (DE) 10 2004 018 063.6

(51) Int. Cl. E05C 19/16

(52) U.S. Cl. 292/251.5

(57) ABSTRACT

The invention relates to a window comprising a window frame and a casement which can be displaced in relation to the window frame, mountings which are arranged between the casement and the window frame and which are used to displace the casement in relation to the window frame, and a handle which is disposed on the casement. The handle comprises control elements and/or sensors and a handle part which can be displaced, particularly rotated, on the casement in various positions of the handle which correspond to different operational positions of the casement. The handle is connected in a wireless manner or via electric lines to electromagnetic or electromechanical locking elements between the casement and the window frame, and/or to electromagnetic or electromechanical functions, in particular coupling elements for at least one or several mountings and/or to an electromechanical drive device which is used to open or close the casement.

The invention relates to a window having a frame and a casement according to the preamble of Claim 1 and to a handle according to the preamble of Claim 41.

Windows of this type are known in many different constructions, for example, as tilting windows, rotary-type tilting windows, sliding windows or as (parallel) tilt-out windows. The casement is opened and closed by means of a handle to which a gearing—particularly a connecting-rod gearing—is connected on the output side, which gearing is directly mechanically connected to the handle and acts upon locking devices for releasing and locking the casement with respect to the frame.

It is also known to open and close windows by means of electromechanical (that is, electromotively driven) drives. In the case of such windows, switches are used for controlling the drives. These embodiments have also been successful per se. However, the operation of these windows is often awkward and complex.

With respect to the state of the art, German Patent Document DE 100 59 582 A1, which suggests a transponder device for monitoring the closed position of a window, is also mentioned as well as German Patent Document DE 2 01 10 780 U1 which suggests a monitoring device having a light barrier for monitoring the closed position of doors.

Based on this background, the invention starts by recognizing the task of further simplifying the handling of windows having electromechanical or electromagnetic components.

The invention achieves this task by means of the object of Claim 1.

Advantageous further developments are contained in the subclaims.

According to the object of Claim 1, the handle has switching elements and/or sensors and the handle is connected in a wireless manner or by way of electric line:
with electromagnetic or electromechanical locking elements between the casement and the frame,
and/or with electromagnetic or electromechanical function elements, particularly coupling elements for at least one or more mountings,
and/or with an electromechanical driving device for opening and closing the casement.

By means if the coupling elements, particularly the pivot bearing is displaced about a first axis, and/or a tilting bearing is displaced about a second axis and, if required, a tilt-out device is displaced into its operating position—in which they each exercise their mounting function—or into a deactivated position—in which they do not act as a pivot point.

A mechanical connection previously to be provided between the handle and the locking devices or function elements for the mountings, such as a gearing—particularly a connecting rod gearing—can thereby be eliminated, which clearly results in advantages with respect to cost and mounting as well as in an increased operating comfort.

The user virtually does not notice that the design has no connecting rod and does not have to become familiar with the operation of new operating and switching elements.

According to an advantageous variant of the invention, as in the case of purely mechanical windows of a conventional type, the handle is used for opening and closing the window, whereas the controlling of the locking and/or function elements takes place by way of electric lines or in a wireless manner.

In this case, it was again found to be particularly expedient for the handle to be used for opening the casement into a rotationally open position about the vertical axis of rotation, while the tilting takes place about a preferably lower horizontal tilting axis by means of an electromotive drive—for example, having a shear-resistant chain.

This embodiment has the advantage that the tilting—which, for example, takes place by far most frequently in an office building—can be carried out automatically, while the rarer rotating—for example, for cleaning the window—takes place manually; so that, for this function, the window does not also have to be equipped with an electromechanical drive. This meaningfully minimizes the manufacturing costs.

The required electronic switching and control unit can be accommodated in a small compact housing on the handle or in the grip collar. The electronic unit, which is preferably arranged at the casement, and the electromotive drives are supplied with power by way of a multi-core cable from the frame to the casement. A remote control by means of a data transmission by wireless communication or by line from and to a higher-ranking control center is also conceivable, for example, in order to tilt and to close a window in a remote-controlled manner and/or in order to remotely monitor the function of the window and its operating condition.

According to another embodiment, it is useful to design the handle, its switches and the pertaining electronic control unit such that, during a pivoting from a first “closed” position into a “rotating position”, the locking element is released and a rotary mounting or hinge is placed in its rotating position. Then the handle itself can be used for the manual opening by means of turning and for the closing. Since the tilting takes place by means of an electric motor, according to a particularly preferably embodiment, this operation can take place by means of an additional switch at the handle which, in turn, is again preferably arranged directly on the handle. In this manner, it is also visually indicated to the user that the function of the rotation is a manual function and that the tilting of the window takes place automatically. The automatic tilting form is meaningfully supplemented by an antisqueeze device.

In another particularly preferred embodiment, the invention therefore implements a window with a frame and a casement, which can be moved into a rotating and tilting position relative to the frame, as well as mountings between the casement and the frame for the moving or hinged connecting of the casement to the frame and a handle arranged on the casement, which handle has a grip part which can be moved into different grip positions at the casement—in particular, can be rotated on a grip shaft—, which correspond to different operating positions of the casement, characterized in that the handle has switching elements and/or sensors for detecting the rotating position of the grip, as well as a manually operable switch arranged directly on the handle for switching a drive for the tilting position, the handle being connected in a wireless manner or by way of electric lines with at least one electromotive locking element for the casement and with at least one electromotive coupling element for the tilting bearing, and the handle being equipped with an electromechanical driving device for the opening and closing of the casement into and out of a tilted position.

According to one of the alternatives of Claim 1, it is also conceivable that the window has at least one electromechanical drive for the automatic opening and closing of the casement. Under certain circumstances, separating locking devices can then be eliminated. However, it is also advantageous in this case for the operation of the casement to take place by way of a handle as it is normally used on windows.

However, particularly for reasons of cost, the combination of an electromagnetic or electromechanical locking of the window and of the coupling of its mountings and a mechanical opening and closing “by hand”, particularly when rotating the casement, is preferred.

In this case, the handle may be provided with at least one indicating device, such as a light-emitting diode, which indicates the operating and functioning condition, particularly with a view to the locking devices, the mountings or the drive directly on the handle element; thus, for example, for indicating to the user that a locking has taken place.

According to another preferred embodiment, rabbet space is constructed between the frame and the casement, and at least one or more locking elements are arranged and distributed in or on the rabbet space, which bridge the rabbet space and have the purpose of locking the casement on the frame in the closed position of the window, in which case the at least one locking element can be controlled in a wireless manner or by way of electric lines corresponding to the grip position of the handle and has an electromagnetically or electromechanically acting closing element. Electromagnetic closing elements are known per se from German Patent Document DE 195 14 051 A1.

The function elements, particularly coupling elements, are preferably designed for engaging and disengaging the pivot bearing and/or the tilting bearing into and out of their operating position, the function elements being controlled in a wireless manner or by way electric lines corresponding to the grip position of the handle.

According to further development of the invention, which can also be considered independently, an electric monitoring device is assigned to the handle, for detecting the grip position of the handle, which, for example, as an arithmetic-logic unit, is designed for detecting and indicating the position of the switching elements or the information of the sensors at the handle. The handle is preferably connected with the monitoring and/or control device in a wireless manner or by way of an electric line. In this manner, it becomes possible to detect and to monitor the position of the handle and therefore that of the window directly at the window or in a central monitoring station of a building.

An electric circuit, particularly a control device, is preferably assigned to the handle directly on the casement, which control device is expediently and compactly arranged in a grip housing, particularly in the manner of a collar. The grip housing may be visibly placed on the casement frame or may be integrated therein. Thus, it can also be arranged in a covered manner in the rabbet space between the casement and the frame.

The invention is particularly suitable for a use on windows whose casement is constructed as a rotary and/or tilting casement, but also on windows whose casement is constructed as a sliding or tilt-out casement.

The casement may be constructed to be frameless, in which case, the handle is fastened to the window pane. However, the casement preferably has a frame for receiving the handle.

It is an important aspect of the handle that it has the grip part which is designed to be moved, particularly to be rotated, into different grip positions, which can be clearly visually differentiated from one another, so that operating positions, which can be differentiated from one another just as clearly, can be assigned to the grip positions. Specifically in this case, the operation of the window is particularly simple without the requirement of additional operating elements, such as key buttons or the like.

Apart from the above, the handle can be designed in many different fashions, particularly in the manner of a loop-type grip, a turning handle, or the like. However, the grip part should always be provided, which can be moved, preferably swiveled, into different grip positions.

The electric circuit and the handle expediently form a functional constructional unit in order to simplify the mounting.

The casement preferably has a casement frame. Likewise, the frame preferably—but not necessarily—has a surrounding construction.

The invention also relates to a window having a device for remotely monitoring the position of a window grip. It is known to monitor the closed position of a window or of a door by means of a reed contact arranged on the window frame, which reed contact cooperates with a permanent magnet fastened to the window casement. However, this does not yet ensure that a closed window is properly locked because, although the window may be leaning against the frame, the window grip may not have been moved into the closed position. In this case, it would be easy to press the window open from the outside.

This is remedied by an embodiment which separately can also be considered to be an invention, according to which the respective position of the grip, but at least its closed position is detected by way of a switching gate. This information is preferably used for monitoring the switching position.

In this case, a switching gate is arranged on the grip shaft operating the closing mechanism, which switching gate is connected directly or in a connection by way of intermediately disposed elements, such as at least one electric line, particularly a bus, and/or a radio link, to a control or monitoring device at the window or at a location spaced away from the window.

The switching gate preferably interacts with a least one electric or magnetic sensor, and the sensors are connected to the control and/or monitoring device by way of the line or radio connection, which control and/or monitoring device may also be constructed as a reporting center.

If the window casement can only be swiveled, it will often be sufficient to indicate only the closed position of the grip. In contrast, in the case of rotating/tilting windows, it may also be desirable to know whether the not closed window is tilted, which may be acceptable, or is swiveled into the open position, which may be unacceptable. In this case, it is therefore recommended to detect and report to the security center all three conceivable positions of the grip (“swiveled open”, “tilted open”, “closed”). The number and arrangement of the position sensors to be controlled by the switching gate therefore depends on the respective monitoring task and the respective window type.

The switching gate may be a mechanical gate; in the simplest case, a trip cam. It may interact, for example, with miniature snap-action switches, often called “microswitches”. The “switching gate” may also consist of at least one permanent magnet, which acts upon one or more reed contacts. The transmission of the switches conditions of the contacts or switches to a reporting center may take place in a wireless manner by way of a radio communication between a battery-powered radio electronic module integrated in the mounting and the reporting center. In order to keep the consumption of battery power as low as possible, it is recommended, particularly for monitoring several windows and/or doors, that the condition of the individual sensor or switches be cyclically queried, so that the radio electronic system emits a signal only as a respective response to such a query (bidirectional operation).

When the window is constructed as a rotating/tilting window whose casement is rotatable about a vertical swiveling axis into a rotating position and about a horizontal axis into a tilting position, according to a particularly preferred embodiment of the invention, it is advantageous to design the handle such that, by means of it, the casement can be moved manually into the rotating position. For this purpose, preferably first switching elements (not shown here) are arranged on the handle such that, when the handle is moved—particularly during the swiveling—, from a first position into a second position, they release the tilting bearing as well as the at least one locking element of the window. In this condition, the window can be rotated open. In contrast, when the window is moved into a tilting position, the switch (for example, a toggle switch or key switch), which can be manually operated from the outside at the handle, is arranged on the handle, by means of which switch, the locking element is released and the tilting bearing is moved into its tilting position.

For this purpose, electromotive drives are suitable which are not visible from the outside and are arranged in the surrounding gap between the window frame and the casement frame, for example, on the window frame, preferably in the manner of module-type units with a housing, which each contain an electric motor, a gearing (of the connecting rod type) and an output element (for example, a locking bolt) which can be moved in and out such that it can in each case be brought into and out of an operating position (not shown here).

The invention finally also provides a handle for a window, particularly for a window according to one of the preceding claims, which has a window frame and a casement, which is movable relative to the window frame, the handle being constructed for the manual opening and closing of the casement, the handle having switching elements and/or sensors, and the handle being connectable in a wireless manner or by way of electric lines with electromagnetic or electromechanical locking elements between the casement and the window frame and/or with electromagnetic or electromechanical operating elements, particularly coupling elements for at least one or more mountings and/or with an electromechanical driving device for the opening and closing of the casement.

In the following, the invention will be described in detail by means of embodiments with reference to the drawing by means of embodiments.

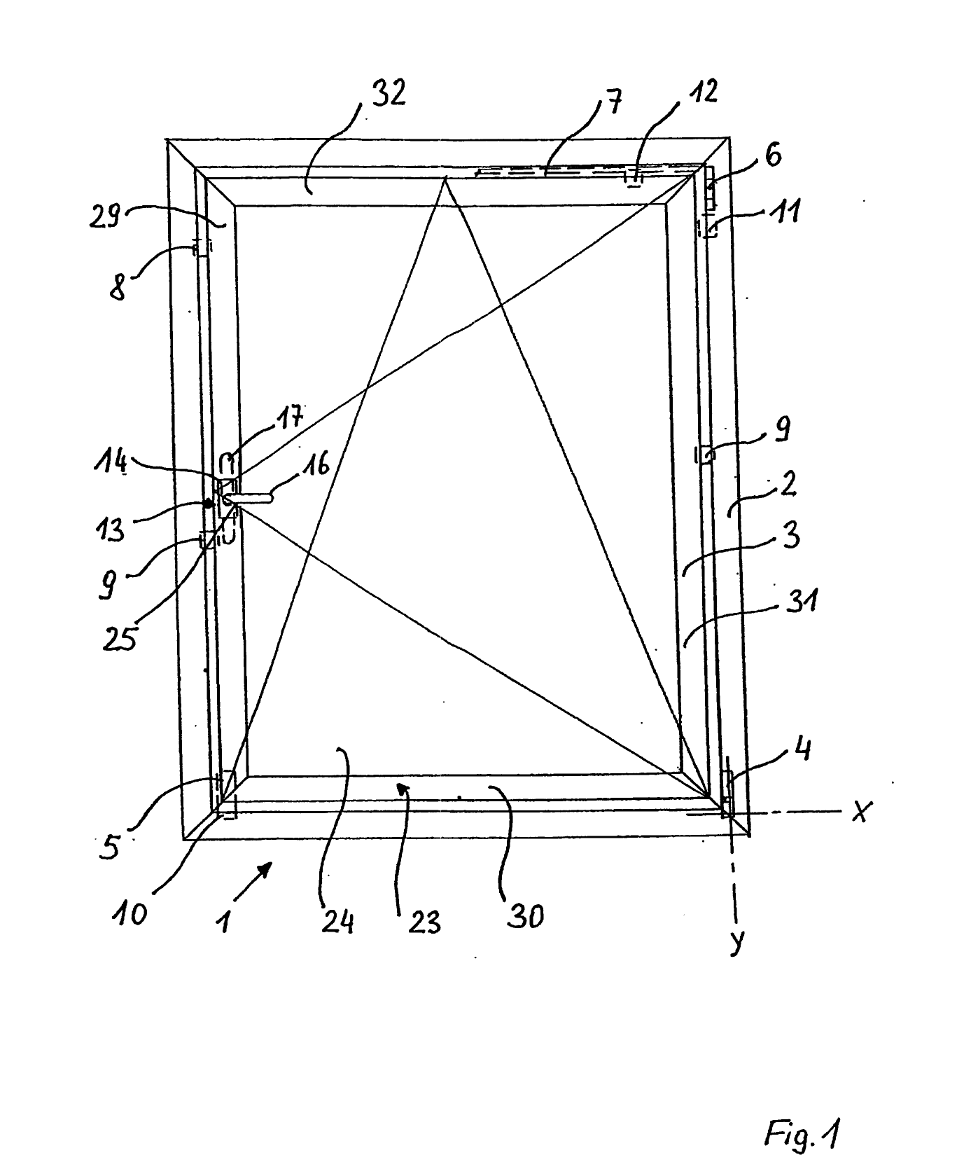

FIG. 1 is a schematic view of a rotating/tilting window having a first handle;

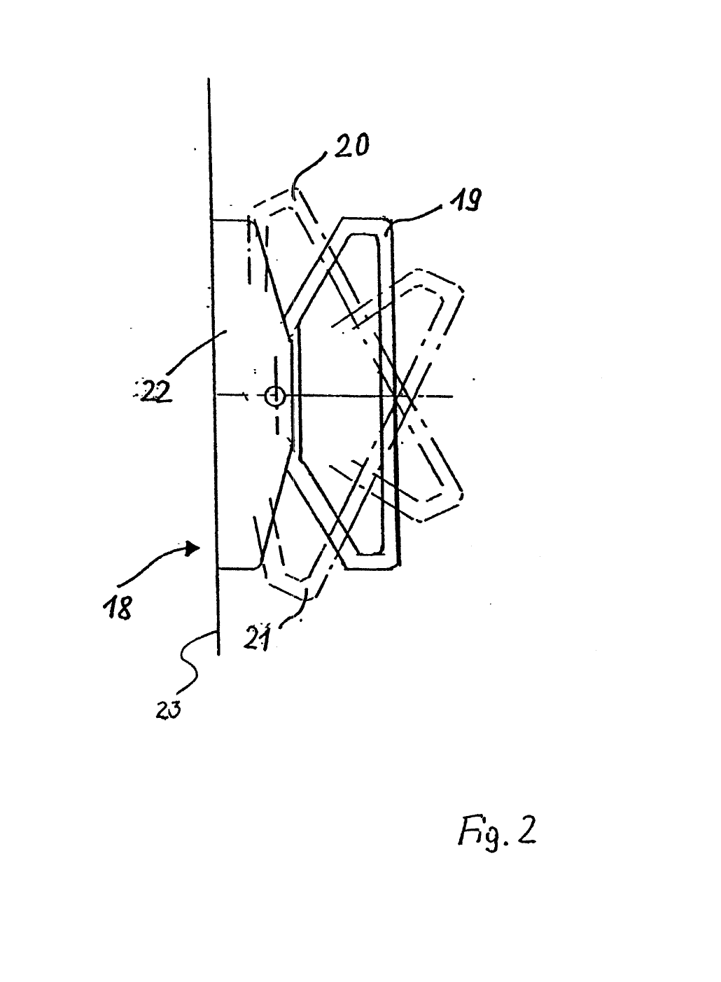

FIG. 2 is a schematic view of another handle for a rotating/tilting window in different grip positions;

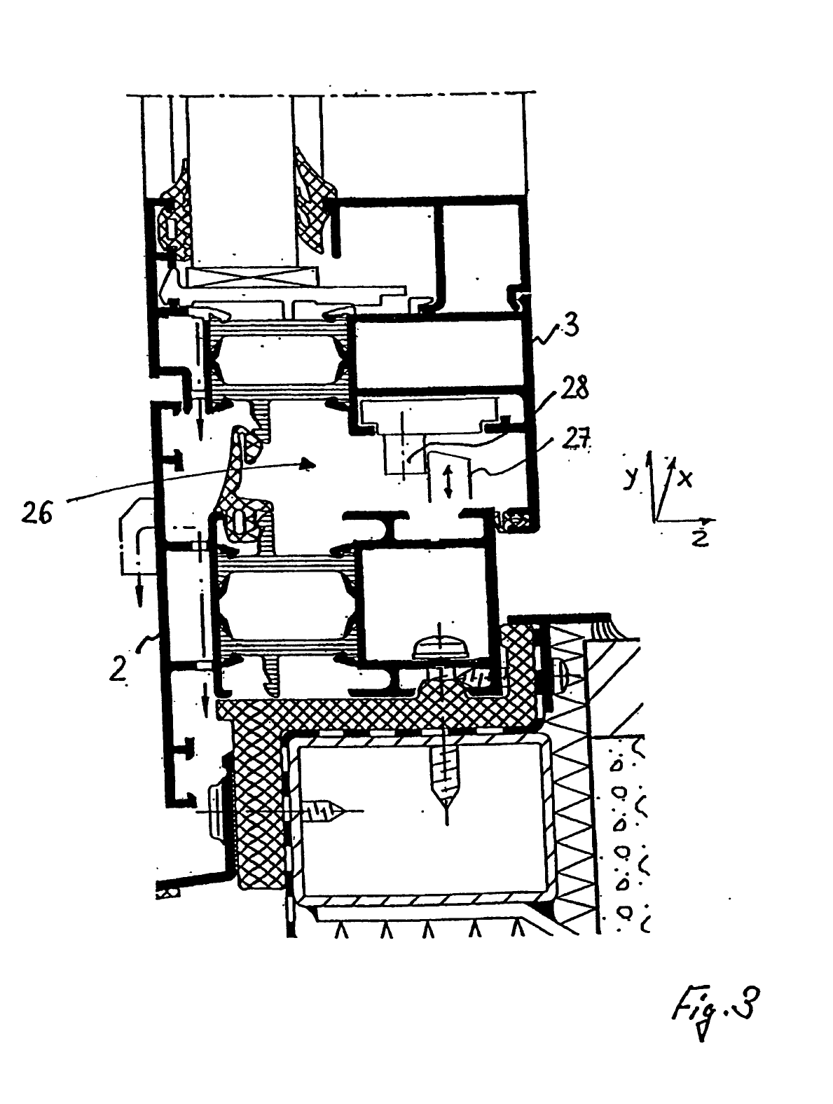

FIG. 3 is a sectional view of a schematically illustrated rabbet space of a window;

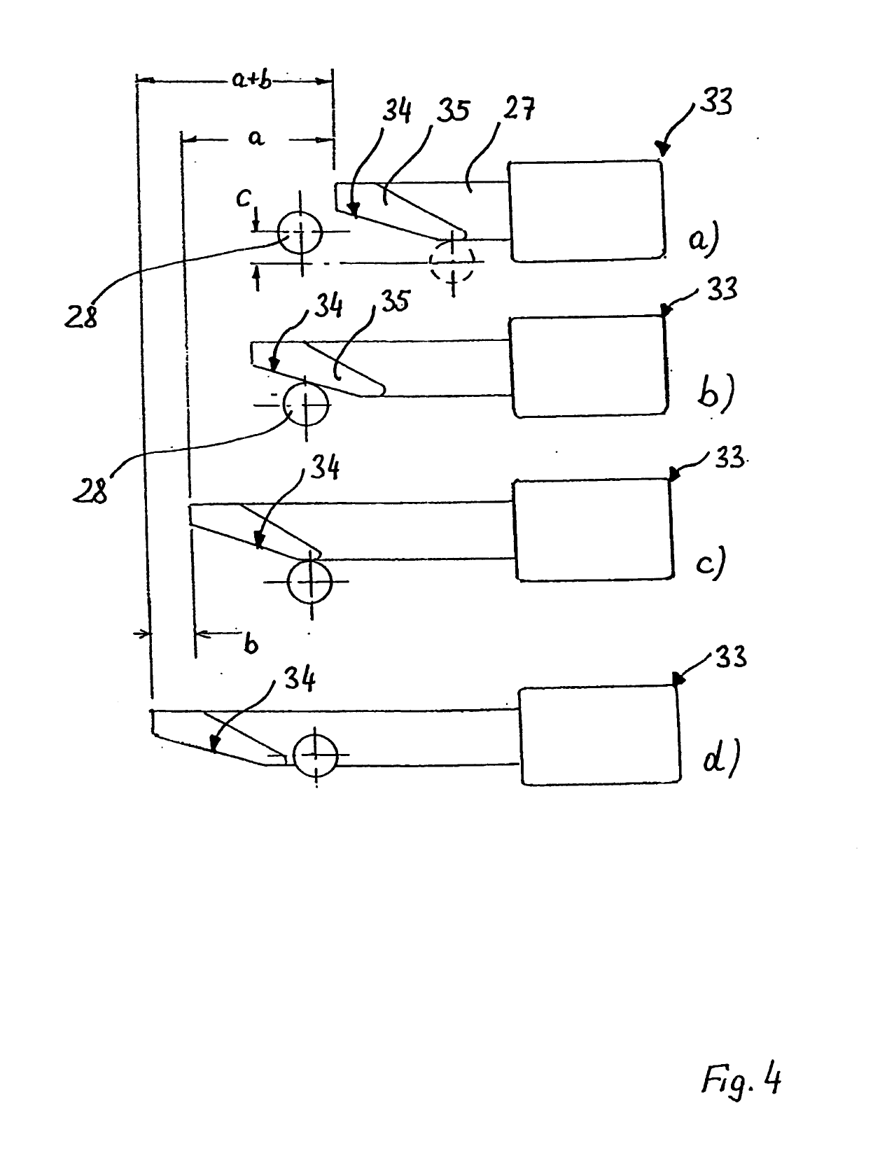

FIGS. 4a-d are schematic views of an electromechanically operated locking device for a window in different operating positions; and

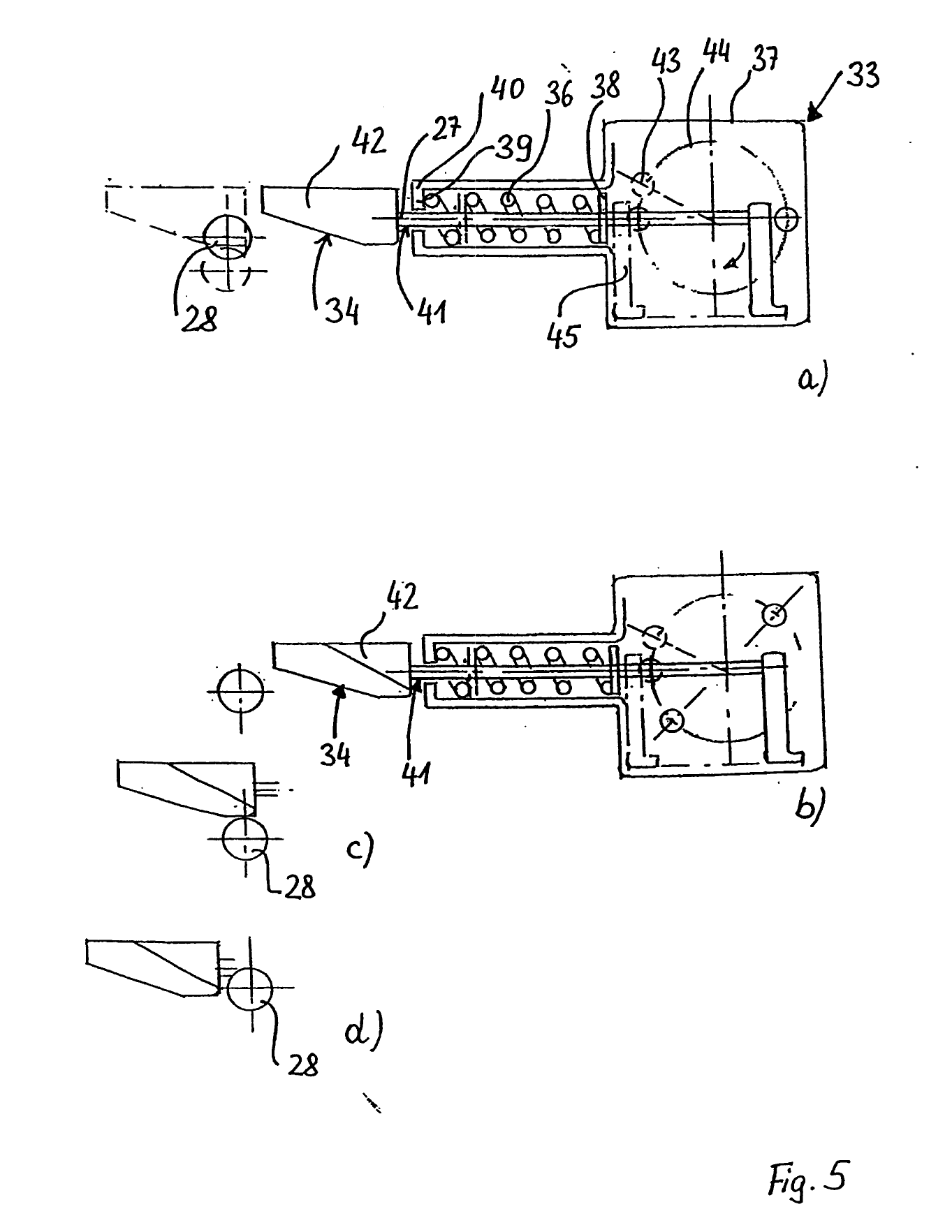

FIGS. 5a-d are schematic views of another electromechanically operated locking device for a window in different operating positions;

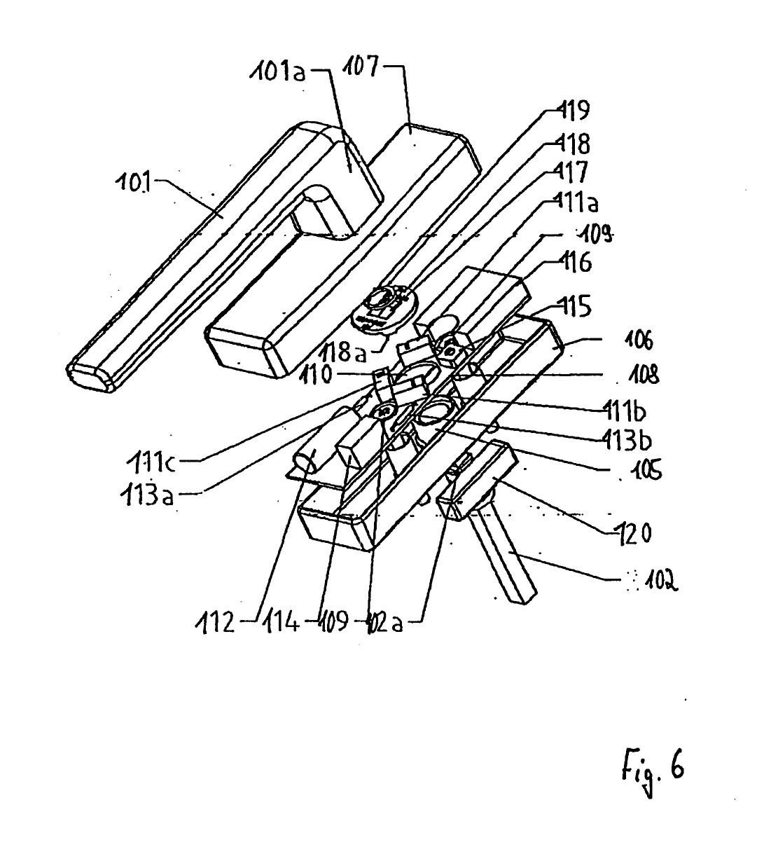

FIG. 6 is an exploded view of the operating grip of a rotating/tilting mounting with position monitoring;

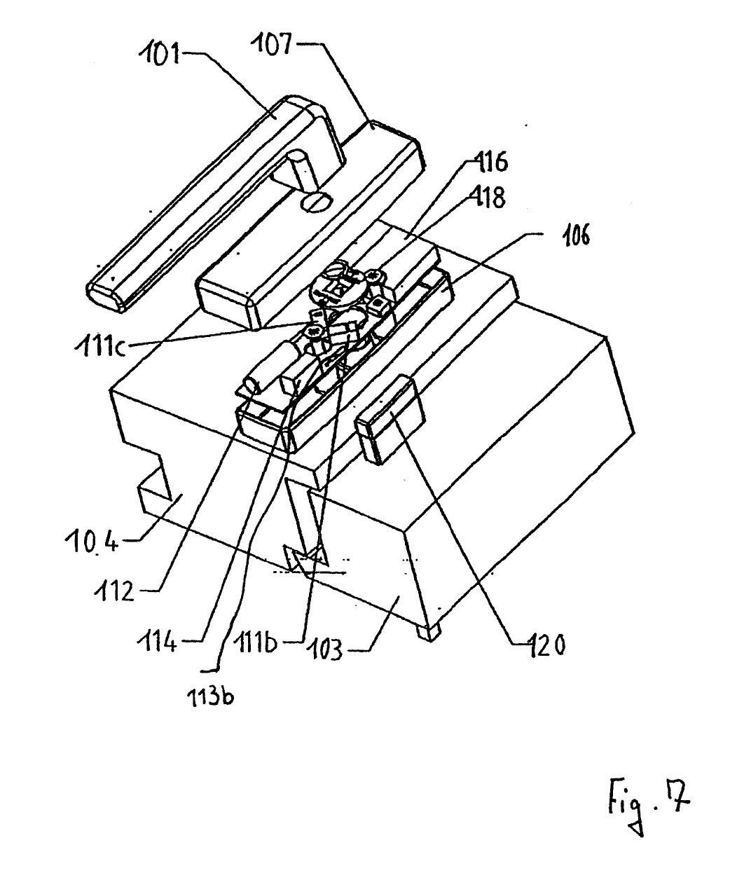

FIG. 7 is an exploded view of the addition of such an operating grip on a window casement; and

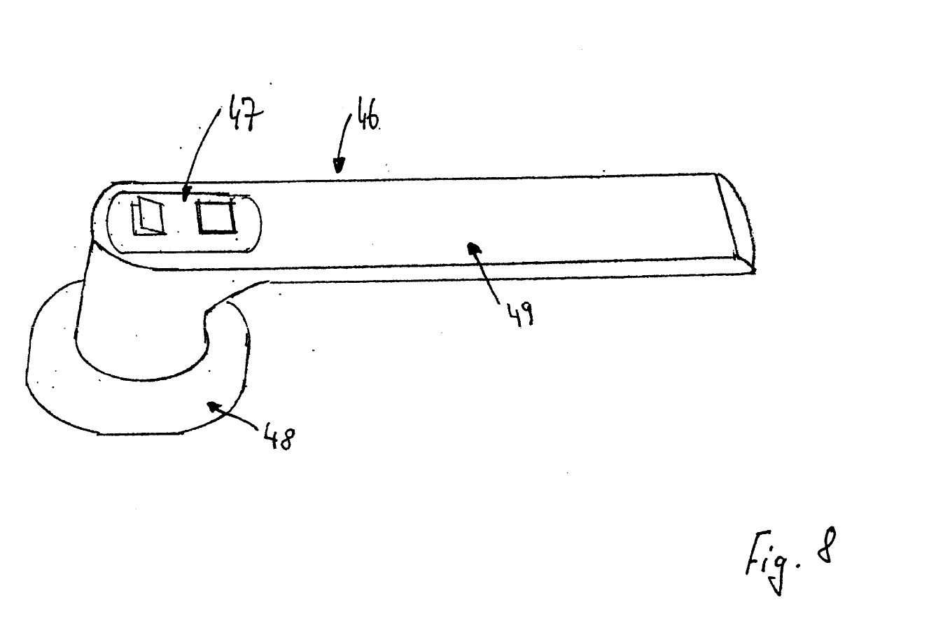

FIG. 8 is a perspective view of a window grip.

FIG. 1 a shows a rotating tilting window 1 having a window frame 2 and a casement 23, which here has a casement frame 3 and accommodates a pane 24.

The rotating tilting window can be tilted about a first axis x horizontally oriented in the normal installed position and can be rotated about a second axis y which is vertical here.

For this purpose, the window 1 has a rotating tilting bearing 4, a tilting bearing 5 which can be moved out, and a pivot bearing 6 further developed as a rotary band as mountings between the window frame 2 and the casement frame 3 for moving the casement, which pivot bearing 6 is fastened to the casement frame 3 and is detachably fixed on the window frame 2. In addition, there is also a tilt-out device 7.

Depending on whether the window is tilted or rotated or whether it is closed, these mountings, or here bearings, are either in their operating position or not. Thus, the tilting bearing 5 is in its operating position during tilting movements, and the pivot bearing 6 is not. In contrast, during rotating movements, the pivot bearing 6 is in its operating position and the tilting bearing 5 is not.

Depending on the construction, the rotary band 6 is detachably coupled in the closed position of the window and in the swiveling position about the Y-axis on the window frame or on the casement frame and is correspondingly fixedly arranged on the casement frame or window frame. In the latter case, the pivot bearing 6 and a tilt-out device 7 form a unit.

Furthermore, in the case of the rotating tilting window illustrated in FIG. 1, functionally in each case at least one electromechanical function element 10, 11 or 12 is assigned to some of the mountings, which are required for the implementation of the mobility between the casement and the window frame—here, to the tilting bearing 5 and the pivot bearing 6 as well as also to the tilt-out device 7, by means of which function element 10, 11 or 12, the mountings 5, 6 and 7, depending on their respective control, are coupled into or out of their operating position, in order to be able to move the casement 23 either into its tilting position or into its rotating position or to lock the casement 23 on the window frame 2 in its closed position.

The tilting bearing 5 and the pivot bearing 6 respectively are “rendered operative” or “inoperative” by way of the electromechanically acting coupling elements 10, 11. The electromechanical element 10 controls or couples the tilting bearing 5 between the casement locking position and the casement rotating position about the X-axis, on the one hand, and the release position for the swiveling position of the casement about the Y-axis.

The electromechanical element 11 provides the fixing of the pivot bearing 6, which is arranged on the casement 23, on the window frame 2 in the casement position and the swiveling movement about the Y-axis, on the one hand, and releases the pivot bearing 6, on the other hand, in the position of the casement 23 in the X-axis.

In addition, the tilt-out device 7 is provided as another movable mounting on the edge of the window between the window frame 2 and the casement frame 3, which tilt-out device 7 is used for limiting the tilting position of the casement relative to the window frame 2. The tilt-out device 7 may also be connected with the rotary band 6, in which case the rotary band 6 is then fixed on the window frame 2 and can be coupled with the casement 23 by way of the tilt-out device. Furthermore, the tilt-out device 7 can optionally, by way of elements not shown here, such as an electric motor and a gearing,—particularly a chain or a cable starting at the tilt-out device—be used for opening and closing the rotating tilting window into and out of the tilting position.

The function element 11 provides a release of the pivot bearing 6 at the casement 23 during rotating movements about the y-axis in its operative position. In contrast, during tilting movements, the pivot bearing is rendered inoperative in its deactivated position. The operations of the other function elements 10, 12 are analogous with respect to the tilting bearing 5 and the tilt-out device 7, whose movements are rendered either inoperative and/or are blocked or released, for example, by electromechanically operable coupling element having movable pins or the like.

Between the window frame 2 and the casement frame 3, locking elements 8, 9 are arranged in a punctiform manner or only at individual mutually spaced points of the rabbet space in or on the rabbet space existing between the two frames, which locking elements 8, 9 bridge the rabbet space and have the purpose of locking the casement 23 at the window frame 2 in the closed position of the window. Here, for example, three locking elements are arranged on the edge of the casement on the side of the rotary band 6 and the edge of the casement frame 3, which is situated opposite the rotary band 6. It is also conceivable to provide additional locking elements 8, 9 of this type on the other sides, particularly the top and bottom side of the window and/or a different number of locking elements 8, 9.

The locking elements 8, 9 can be controlled here in a wireless manner or by way of electric lines (not visible here) and have an electromagnetically or, in particular, electromechanically acting closing element. An electromechanical closing element is preferred in order to generate a sufficiently high closing force, optionally in connection with additional transmission elements, such as tapered slopes, eccentrics, spreader wedges, or the like. In this case, the closing should preferably take place by means of the electromechanical drive and the opening should preferably take place by means of the electromechanical or electromotive drive or, for example, by means of a spring. The spring may be advantageous because generally less time is available during the opening of a window than during the closing and subsequent locking.

A handle 13 arranged on the casement frame 13 is used as the operating element for the casement 23, which handle 13 has a grip 25 movable—here, rotatable—on a shaft relative to the window frame 3 into different grip positions.

A user can directly visually differentiate between the grip positions of the handle 13. In the mutually different grip positions, which differ by various angles, here 90°, provided here, for example, for a rotating tilting window, the casement is either locked, can be tilted or rotated.

Here the handle 13 is used for tilting as well as for rotating the window; thus, for generating the mechanical force in order to move the casement 23 relative to the window frame. However, the handle 13 is not also used, as otherwise customary, for operating the locking elements and/or the mountings by way of a mechanism. This task is achieved here without any mechanical connection with the mountings 4, 5, 6, 7 by means of electric lines or in a wireless manner in that the switching position of the handle 13 is detected by way of a detecting device, such as switching contacts or sensors (for example, reed contacts) and is used for controlling the electromagnetically or electromechanically acting locking and function elements in order to use the mountings either in the tilting function position or the rotating function position or to close the window.

In FIG. 1, the handle 13 is designed such that the grip position pointing downward corresponds to the locked position of the window in which all locking and function elements 8, 9; 10-12 are in the latched or locked position.

In contrast, the grip position 16 corresponds to the possibility of changing the casement into its rotating position, in this grip position, the locking elements 8, 9 and the function element 10 for the tilting bearing 5 being unlocked.

In the tilting position—here, in the upward grip position of the handle—, in contrast, the casement 23 can be tilted about its—here, lower—horizontal axis of rotation, so that, in this grip position, the locking elements 8, 9 and the function element 11 for the pivot bearing 6 are unlocked.

Positions 16 and 17 can also be exchanged when the switching sequence—tilting position before the rotating position—is to be implemented, which is the mostly required approach in some countries. In this case, grip position 16 would be the tilting position, and grip position 17 would be the rotating position.

As an embodiment, FIG. 8 shows a handle constructed as a rotating window grip 46 for being placed on the casement. The rotating window grip has a grip collar 48 which can be non-rotatably fastened to the casement and on which the actual grip part 49 is rotatably disposed. In this manner, a type of grip shaft is implemented which can be rotated on the collar. Switching elements may be arranged in the collar which are operated during the rotation of the grip in order to, for example, release closing elements for locking the window and preferably move the pivot bearing into its rotating function position. Then, with the exception of the fastening, for example, by means of screws, not mechanical connection, for example, in the manner of a mechanical gearing, is required between the collar and the casement. However, preferably, in addition to the fastening, an electric plug-in connection is implemented between the casement and the handle (not visible here), so that the electric connection between the casement and the handle is established simply by a plugging-in.

The casement of a rotating window or preferably of a rotating/tilting window can be manually brought into its rotating position by means of this handle or by means of this window grip. An additional switch 47 (such as a toggle switch and/or push button switch, for example, in the manner of a rocker switch) on the side facing away from the casement permits the controlling of an electromotive drive (not shown here) for the opening and closing of the casement into and out of its tilting position.

Handle 13 is connected with the locking elements 8, 9 or the mountings by way of no mechanical elements, such as a gearing, particularly a connecting rod arrangement. By the elimination of a mechanical gearing connection between the handle and the locking elements and mountings, the expenditures for producing the window are reduced and, on the other hand, the possibility is created of transmitting the detected grip position by means of a wireless or other connection of the handle or of the switching and/or sensor elements assigned to the handle to a higher-ranking—not shown here—monitoring device so that it becomes possible, for example, to centrally detect and monitor the position of the windows of a building without additional sensors between the window frame and the casement frame.

The switching and/or sensor elements of the handle 13 as well as optionally additional electric or electronic components, such as interface modules to a data and/or energy bus of a building automation system, according to an advantageous embodiment of the invention, can be accommodated in a grip housing 14—here, constructed as a collar toward the outside—, without any disadvantageous change of the appearance in comparison to conventional purely mechanically acting handles.

As an alternative, it is also conceivable—not shown here—to house an electric circuit for the handle 13 in or in the proximity of the handle 13, thus, in the rabbet space, a chamber or in a recess of the casement frame.

On the one hand, the handle 13 completely or partially permits the customary handling of the window and, on the other hand—depending on the design—is used as a switching and/or information module because of its electronic system having sensor and/or switching elements.

FIG. 2 shows another embodiment of a handle 18 for a rotating tilting window. The handle illustrated in FIG. 2 has a loop-type grip 19 which, in the manner of a rocker, can be rotated or tilted into different grip positions relative to a grip housing 22 fastened on the casement 23. In the grip position characterized by reference number 19, the window is locked; in the position marked with reference number 20, it can be displaced into its tilting position; and in the position of the handle 18 marked with the reference number 21, it can be displaced into its rotating position.

In an embodiment as a tilting or rotating window, only two grip positions are correspondingly required. In the embodiment according to FIG. 8, even only the rotating position is required, since the tilting position is operated by way of the separate switch 47.

The number of locking elements varies according to the casement size. In the case of a rotating tilting window of a smaller construction, at least one locking element 11 is required. As a priority, a locking element is provided on the grip-side vertical frame member 29. In the case of larger window casements and taking into account the window installation positions, additional locking elements may be provided on the four frame members 29-32 of the casement frame 3, which locking elements lock the casement in a virtually punctiform manner or at points.

FIG. 3 is a sectional view of a frame of a window having a window frame 2 and a casement frame 3, in the rabbet space 26 of one of the locking elements 8, 9, it being schematically illustrated which of the locking elements 8, 9 can be electromechanically operated. The locking elements 8, 9 each comprise an electromechanically driven, movable locking slide 27, which is movable in the direction of the pane plane in the direction of the casement frame 23 parallel thereto and, in its locking position, reaches behind a locking abutment 28, such as a roller or a bolt, which is stationary at the casement or cannot be moved relative to the casement 23.

As an alternative, the locking slide 27 may also be arranged on the casement and will then interact with the locking abutment on the window frame. In this case, the electromotive drive for the locking slide is also arranged on the casement frame.

A schematic representation of such a locking device 8′ in different operating positions is illustrated in FIG. 4.

FIG. 4 is a purely schematic view of an electromechanical driving device 33 which has an electric motor and preferably a gearing on its output side (not shown here). This driving device 33 is preferably arranged on the window frame (or, as an alternative, on the casement).

According to FIG. 4, the locking slides 17 are equipped with radial cams, particularly tapered slopes 34, in such a manner that, during the locking with a predefined force, the casement 23 is pulled by way of a path “c” in the direction of the window frame 2, so that the casement 23 will rest tightly on the window frame with a predefined force.

The gearing permits the linear movement of the locking slide 2 in its axial direction or in the direction of the corresponding window part—here, of the casement 3—in the direction of the locking abutment 28 fixed to the movable casement—not shown here.

On the side of the locking slide 27 facing the locking abutment 28, a radial cam, here a tapered slope 34, is constructed which can also be constructed on a projection 35 molded radially onto the actual locking bolt and extending only along a portion, particularly an end region of the locking slide 27.

The function of this arrangement is as follows.

During the closing of the window, the locking slide 27 is moved out of its moved-in position (FIG. 4a) on the window frame 2 parallel to the casement frame 3, until the locking slide 27 with its tapered slope 34 comes to rest on the outside radius of the locking abutment 28 (FIG. 4b). When the locking slide 27 is moved out farther, the locking abutment 28 on the casement 3 as well as the casement 3 itself are pulled perpendicularly to the pane plane in the direction of the window frame 2, until a locking position has been reached, in which the path of the tapered slope 24 has been traveled completely, so that the closed position can also be maintained when the motor is not energized (locking position of FIG. 4c).

As an alternative, the closing path along the tapered slope 34 can be traveled in reverse for the unlocking (not shown).

In order to be able to carry out the opening of the casement as fast as possible, however, it is also conceivable to move the locking slide 27 out farther until the latter reaches a position in which it slides past the projection 35 with the tapered slope 34, so that the casement 23 can detach from the window frame 2 particularly rapidly (FIG. 4d).

The path “a” to be linearly traveled by the locking slide 27 in its displacing direction is clearly longer during the locking of the window than the path “b” to be traveled during the unlocking before the opening (in particular, the a/b ratio is greater than 2/1), so that also the time required before the window is unlocked and can be opened after the operation of the operating element, particularly after the rotating of the handle 13, is shorter than the time which the drive requires for locking the window after the, for example, manual closing and a subsequent rotating of the handle 13. This is advantageous because particularly the opening should always be fast, whereas the user is not bothered by a longer time period for the locking after the closing of the window or after the casement was placed against the window frame 2.

An alternative embodiment is illustrated in FIG. 5. Here, the locking takes place analogously to FIG. 4, but the unlocking takes place by means of an unlocking spring 36.

A drive housing 37 for the electric motor and a gearing is designed such in this case that it also accommodates the unlocking spring 36, particularly a coil spring.

The unlocking spring 36 surrounds the locking slide 27 and is supported on two stops 38, 39, which concentrically surround the locking slide 27, one of the stops 38 surrounding the locking slide 27 in a disk-type manner and being axially fixed thereto, and the other stop being constructed as the housing wall 40 of the drive housing 34, which is penetrated by the locking slide 27 in a movable manner. A head part 42 of a given length, which again is provided with the tapered slope 34, is constructed on a projection 41 protruding from the drive housing 37.

The locking takes place as according to FIG. 4. However, an eccentric device with an eccentric pin 43 is constructed in the drive housing 37 at the end of the locking slide 27, which eccentric pin 43 moves on a circular path 44 and, during the closing, acts upon a radial stop 45 on or around the locking slide 27, which is fixedly connected with the locking slide 27, so that the eccentric pin by way of the stop 45 advances the locking slide (27) toward the outside out of the drive housing (into the locking position of FIG. 5c).

When the eccentric pin is moved farther, it slides past the edge of the stop 45 so that the locking abutment 28 is released again enabling the unlocking spring 46 to relax.

In contrast, according to FIG. 5b, the circular path 44 of the eccentric pin 43 is dimensioned and coordinated such that the closing position is already reached after less than half the circular path 44, and that, during the continued sweeping over the circular path 44, the locking slide 27 moves out more until it again reaches a position in which the head part 42 is released so that the casement 23 can again detach rapidly from the window frame 2 (FIG. 5d).

Kinematic reversals, for example, by means of radial cams on the locking abutments, can also be implemented. Likewise, the electromagnetic drive can be placed in the casement, and the abutment can be placed on the window frame. The path of the locking bars can also take place or be formed along the frame rabbet between the window frame and the casement frame.

The handle—in the following called “window grip”—of FIGS. 5 and 6 will now be considered in greater detail. Here, the handle, in each case, has a grip shaft or grip bearing, preferably on the collar, which is also particularly advantageous in the above-mentioned embodiments.

By means of a four-cornered grip shaft 102, the grip 101 operates a closing mechanism—not shown here—of a rotating/tilting window with a casement frame 4 linked to a window frame 103. For a better clarity, the grip shaft 102 is not shown in FIG. 7. The grip shaft 102 is disposed in a molded-on bush 105 of the bottom part 106 of the grip housing fastened on the casement frame 104. The grip housing consists of the above-mentioned bottom part 106 and of a shell-shaped covering 7. The bottom part 106 is fastened to the casement frame 104 by means of two countersunk screws 109 and accommodates a printed circuit board 108 which carries three microswitches 111a, 111b and 111c distributed around the passage opening 110 for the grip shaft 102 at an angular spacing of 90°. The angular spacing of 90° respectively corresponds to the three angular positions of the grip 101 for the three switching positions “closed”, “swiveled open” and “tilted open” of the window mounting. At least the covering 107 of the grip housing 6, 107 consists of a material, preferably a plastic material, which transmits radio waves. In addition, a holding device for a battery 12, two reed contacts 113a and 113b, a terminal strip 14, a lid contact 115 as well as a radio electronic module 116 are arranged on the printed circuit board 108.

In the assembled condition, the four-cornered pin 102a of the grip shaft 102 extends through the square central opening 117 of the switching gate 118 into the holding part la of the grip 101 and, during a rotating movement of the grip 101, therefore takes along the switching gate in the rotating direction. A securing ring 119 is used for securing the position of the switching gate on the grip shaft. As a function of the angular position of the grip 101 and thus of the closing condition of the window mounting, the control cam 118a of the switching gate actuates one of the three microswitches 111a, 111b, 111c and thereby closes or opens an electric circuit extending by way of this microswitch. The radio electronic unit is connected by way of strip conductors on the printed circuit board 108 with the terminal strip 114 as well as the microswitches 111 and responds to their respective switching condition. Either at given time intervals or as a response to a radio query from a safety center, the radio electronic system sends a coded signal to the center which characterizes the switching condition of the microswitches and thus the respective position of the grip 101. In this manner, the respective window grip position is remotely monitored. The radio electronic system 116 is supplied with power by the long-time battery 112.

By way of the terminal strip 114, addition sensors can be connected to the radio electronic unit, such as a glass breakage sensor, a shock sensor or a magnet sensor. The radio electronic unit 116 also transmits the alarm signals of such additional sensors to the center. When the window is closed, the reed contact 113b is situated opposite a permanent magnet carried by the window frame 103 and surrounded by a housing 120 and therefore indicates by its switching condition whether the window 104 is actually closed. This switching condition is also reported to the center by way of the radio electronic system 116. In contrast to the initially mentioned known closing monitoring systems, here, the magnet is arranged in a stationary manner and the reed contact is arranged in a movable manner. By means of the radio electronic unit, a stationary wiring between the sensors 111, 113 and the center is saved. The reed contact 113a situated on the opposite side is used for the same purpose if the window casement cannot be attached, as in the illustrated example, on the left but on the right.

Instead of mechanically operated microswitches, magnetically operated contacts, such as reed contacts, can also be used as angle position sensors for the grip 101. The switching gate 118 will then carry one or more permanent magnets instead of one or more cams 118a. Also, the switching gate does not absolutely have to be disposed directly on the grip shaft 102 but can be coupled with the latter by way of a gearing.

In order to also be able to retrofit already existing grip mountings with a device for remotely monitoring the grip position, a further development of the invention provides that the printed circuit board 108 is not installed in the grip housing 106, 107, but is arranged in a backing frame to be inserted between the grip housing or grip mounting and the casement frame 104, the contour of the backing frame preferably being adapted to the contour of the grip housing 106, 107. As described above, the printed circuit board in the backing frame carries the sensors as well as the radio electronic module. If it covers the area of the dimension of the grip shaft 102, it has a passage opening 110 for the grip shaft, as required, lengthened by the height of the backing frame.

The described angular position monitoring for the closing elements can be used not only for windows but also for doors, container as well as fastening devices, such screwed fastenings, or for other purposes. Instead of reed contacts, Hall sensors or other magnetic microsensors can be used, particularly because of their small space requirement.

Reference Symbols:

Rotating tilting window 1
Window frame 2
Casement frame 3
Rotating tilting bearing 4
Tilting bearing 5
Rotary band 6
Tilt-out device 7
Locking elements 8, 9
Electromechanical element 10, 11, 12
Handle 13
Grip housing 14
Locking position 15
Rotating position 16
Tilting position 17
Handle 18
Loop-type grip 19
Grip position 20, 21
Grip housing 22
Casement 23
Pane 24
Grip 25
Rabbet space 26
Locking bolt 27
Closing part 28
Frame members 29-32
Driving device 33
Tapered slope 34
Projection 35
Paths a, b
Unlocking spring 36
Driving housing 37
Stops 38, 39
Housing wall 40
Projection 41
Head part 42
Eccentric pin 43
Circular path 44
Stop 45
Handle 46
Switch 47
Grip collar 48
Grip part 49
Grip 101
Grip shaft 102
Window frame 103
Casement frame 104
Bush 105
Bottom part 106
Covering 107
Printed circuit board 108
Countersunk screw 109
Passage opening 110
Sensor 111
Microswitch 111a, 111b, 111c
Battery 112
Sensor 113
Reed contacts 113a, 113b
Terminal strip 114
Lid contact 115
Radio electronic module 116
Central opening 117
Switching gate 118
Control cam 118a
Housing 120
Axes x, y
Paths a, b, c

1. A window comprising:
a) a window frame and a casement, which can be moved relative to the window frame;
b) mountings between the casement and the window frame for the moving of the casement relative to the window frame;
c) a handle arranged on the casement, which handle has a grip part which can be moved into different grip positions at the casement, which positions correspond to different operating positions of the casement;
d) one of switching elements and sensors, for determining the grip positions; and
e) one of the following controlled by one of the switch elements and sensors
i. electromagnetic or eletromechanical locking elements between the casement and the window frame,
ii. electromagnetic or electromagnetic function elements, particularly coupling elements for at least one or more of the mountings and
iii. an electromechanical driving device for opening and closing the casement.

2. A window according to claim 1, wherein one of the switching elements and sensors for detecting the grip rotating position as well as a manually operable switch are arranged directly on the handle, for switching a drive for the tilting position, where the handle connected with at least one electromotive locking element for the casement and with at least one electromotive coupling element for the tilting bearing, and the handle being connected by way of electric lines or a radio link with an electromechanical driving device for opening and closing the casement into and out of a tilting position.

3. A window according to claim 1 wherein the handle is connected with one of the locking elements and the mountings without mechanical elements.

4. A window according to claim 1, wherein the window frame and the casement are constructed without connecting rods.

5. A window according claim 1, wherein the handle is designed for the manual opening and closing of the casement.

6. A window according to claim 5, wherein the handle is designed for the manual opening and closing of the casement into and out of a rotating position.

7. A window according to claim 6, wherein the handle includes a manually operable switch for operating an electromechanical driving device at a tilt-out bracket for the automatic opening and closing of the casement into and out of a tilting position.

8. A window according to claim 1, wherein an electronic monitoring device for monitoring the grip position of the handle is assigned to the handle.

9. A window according to claim 8, wherein the handle is connected in one of a wireless manner and an electric line with the monitoring device.

10. A window according to claim 1, including a rabbet space between the window frame and the casement, and in that at least one or more of the locking elements are arranged and distributed in or on the rabbet space, where the locking elements bridge the rabbet space and lock the casement on the window frame in the closed position of the window, such that at least one locking element is responsive to the grip position of the handle, and has an electromagnetically or electromechanically acting closing element.

11. A window according to claim 1, wherein the function elements, are designed for the engaging and disengaging of one of a pivot bearing and a tilting bearing in and out of their operating position, and the function elements responsive to the grip position of the handle.

12. A window according to claim 1, wherein one of the mountings, serves as a tilt-out device for limiting the tiltability or rotatability of the casement.

13. A window according to claim 12, wherein the electromechanical drive for the opening and closing of the window is assigned to the tilt-out device.

14. A window according to claim 12, wherein one of the function elements is assigned to the tilt-out device.

15. A window according to claim 1, wherein the handle is connected in a wireless manner or by way of at least one data line with a monitoring device.

16. A window according to claim 1, wherein an electronic circuit for one of switching elements and sensors assigned to the handle directly on the casement.

17. A window according to claim 16, wherein the electronic circuit of the handle is moveably mounted to the grip housing.

18. A window according to claim 1, wherein the casement is constructed as one of a rotating or tilting casement and as a rotating and tilting casement.

19. A window according to claim 1, wherein the casement is constructed as one of a sliding casement and a parallel/tilt-out casement.

20. A window according to claim 1, wherein the casement is one of a frameless construction and a casement frame.

21. A window according to claim 1, wherein the window frame has a surrounding construction.

22. A window according to claim 1, wherein an electric circuit for the handle is arranged in one of the handle or in the proximity of the handle, and a rabbet space, a chamber or a recess of the casement frame.

23. A window according to claim 16, wherein the electronic circuit and the handle form a functional construction unit.

24. A window according to claim 1, wherein the handle is equipped with at least one indicating device, which indicates the operating and functioning condition of one of the locking devices, the mountings and the drive.

25. A window according to claim 1, wherein the handle, its switch and a pertaining electronic monitoring and/or control device are designed such that the handle is used for the manual opening of the casement into a rotationally open position about the vertical axis of rotation, while the tilting takes place about a lower horizontal tilting axis by means of an electromechanical driving device.

26. A window according to claim 1, wherein an electronic switching and control unit for the electromechanical driving device is arranged in a housing on the grip.

27. A window according to claim 1, wherein a multi-core cable is laid from the window frame to the casement frame, which cable is used for the voltage supply to one of the electromechanical driving device and the data transmission.

28. A window according to claim 1, including a electronic switching and control unit connected by radio or by line with a higher-ranking control center.

29. A window according to claim 1, wherein the handle is a rotating window grip on whose side facing away from the casement is arranged one of the switches.

30. A window according to claim 29, wherein a manually operable switch, which is accessible from the outside, is constructed on the grip.

31. A window according to claim 1, including a device arranged on a grip shaft of the window grip which operates the closing mechanism for determining the position of the grip shaft, and the switching gate connected to a monitoring device.

32. A window according to claim 31, wherein the monitoring device is arranged directly on the window grip.

33. A window according to claim 31, wherein the monitoring device is arranged at a location spaced away from the window.

34. A window according to claim 31, wherein the switching gate interacts with at least one electric or magnetic sensor, and the sensors are connected to the control and/or monitoring device.

35. A window according to claim 31, wherein the switching gate interacts with at least two sensors arranged in an angularly offset manner in the rotating direction of the grip shaft.

36. A window according to claim 1, wherein, in the case of a rotating/tilting mounting, three sensors are provided which are assigned to different grip position correspondingly.

37. A window according to claim 1, wherein the sensors are constructed as electric microswitches, and the switching gate is a mechanical gate with at least one control cam.

38. A window according to claim 1, wherein the sensors are constructed as magnetically operable contacts, and the switching gate carries at least one magnet.

39. A window according to claim 1, wherein the sensors are arranged on a printed circuit board held by the bottom part of the grip mounting, which printed circuit board also carries a radio electronic module.

40. A window according to claim 1, wherein the sensors as well as a radio electronic module are arranged in a backing frame on a printed circuit board, which backing frame is to be inserted between a grip housing and the casement frame, and the printed circuit board has a passage hole for a grip shaft lengthened by the height of the backing frame.

41. A window according to claim 39, having a printed circuit board at least partially covering the dimension area of a grip shaft, of the grip part, and wherein the printed circuit board has a passage opening for the grip shaft.

42. A window according to claim 39, wherein at least one magnetic sensor is arranged on the handle, which magnetic sensor interacts with a magnet fastened to the window frame.

43. A window according to claim 1, wherein the handle is a rotating window grip on whose side facing away from the casement, a manually operable switch is arranged.

44. A window according to claim 43, including a device arranged on the grip shaft of the window grip which operates the closing mechanism for determining the positin of the grip shaft, and the switching gate is connected to a monitoring device.

45. A window according to claim 1, comprising:
an electrical handle system which includes a window frame;
a casement movable relative to the window frame, by monitoring the handle system;
comprising:
one of switching elements and sensors for determining the position of the handle; and
connected with one of electromagnetic and electromechanical locking elements between the casement and the window frame and/or with electromagnetic or electromechanical function elements, for at least one or more mountings and an electromechanical driving device for the opening and closing of the casement.

46. A handle system according to claim 45, wherein the handle has switching elements and/or sensors for detecting the grip rotating position as well as a manually operable switch arranged directly on the handle, for switching a drive for the tilting position.

47. A handle according to claim 45, wherein the handle is fastened to the casement and is connected with the locking elements and/or the mountings without mechanical elements.

48. A handle according to claim 45, wherein the handle has a grip collar, on which a grip is rotatably disposed, the grip collar being non-rotatably fastened to the casement, and the electric circuit in the grip collar being in an operative connection with one of drives for the locking elements and the mountings and opening and closing of the window.
